(19) United States
(12) Patent Application Publication
(10) Pub. No.: US 2008/0165159 A1
(43) Pub. Date: Jul. 10, 2008

(54) Force-based input device having a modular sensing component

(76) Inventors: David A. Soss, Salt Lake City, UT (US); James K. Elwell, Salt Lake City, UT (US); James R. Mullins, Centerville, UT (US)

Correspondence Address: THORPE NORTH & WESTERN, LLP., P.O. Box 1219, SANDY, UT, 84091-1219, US

(21) Appl. No.: 12/002,334

(22) Filed: Dec. 14, 2007

Related U.S. Application Data
(60) Provisional application No. 60/875,108, filed on Dec. 14, 2006.

(51) Int. Cl. G06F 3/045

(52) U.S. Cl. 345/174

(57) ABSTRACT

A force-based input device responsive to an applied force to determine a location and/or magnitude of the applied force. The input device comprises a fixed frame and a base support, having an input member configured to receive the applied force and to displace relative to said fixed frame in response to the applied force. The input device is modular in the sense that it comprises a separate module or structure that relates the fixed frame and base support components to one another, as well as constraining these in all directions. The constraining module further comprises a sensing component (such as an isolated beam structure) defined therein by one or more configurations formed in the constraining module. One or more sensors are provided that are operable with the sensing component of the constraining module, which sensors are located in a region of high stress strategically provided by the various configurations of the module.

### RELATED APPLICATIONS

This application claims the benefit of U.S. Provisional Application Ser. No. 60/875,108, filed Dec. 14, 2006, and entitled, “Force-Based Input Device Utilizing a Modular or Non-Modular Sensing Component,” which is incorporated by reference in its entirety herein.

### FIELD OF THE INVENTION

The present invention relates generally to input devices, and more particularly to force-based input devices utilizing one or more means for detecting an applied force about an input component for the purpose of receiving, measuring and processing one or more signals corresponding to the applied force to determine one or both of location and magnitude of the applied force about the input component.

### BACKGROUND OF THE INVENTION AND RELATED ART

Input devices (e.g., a touch screen or touch pad) are designed to detect the application of an object and to determine one or more specific characteristics of or relating to the object as relating to the input device, such as the location of the object as acting on the input device, the magnitude of force applied by the object to the input device, etc. Examples of some of the different applications in which input devices may be found include computer display devices, kiosks, games, automatic teller machines, point of sale terminals, vending machines, medical devices, keypads, keyboards, and others.

Currently, there are a variety of different types of input devices available on the market. Some examples include resistive-based input devices, capacitance-based input devices, surface acoustic wave-based devices, force-based input devices, infrared-based devices, and others. While providing some useful functional aspects, each of these prior related types of input devices suffer in one or more areas.

Resistive-based input devices typically comprise two conductive plates that are required to be pressed together until contact is made between them. Resistive sensors only allow transmission of about 75% of the light from the input pad, thereby preventing their application in detailed graphic applications.

Capacitance-based input devices operate by measuring the capacitance of the object applying the force to ground, or by measuring the alteration of the transcapacitance between different sensors. Although inexpensive to manufacture, capacitance-based sensors typically are only capable of detecting large objects as these provide a sufficient capacitance to ground ratio. In other words, capacitance-based sensors typically are only capable of registering or detecting application of an object having suitable conductive properties, thereby eliminating a wide variety of potential useful applications, such as the ability to detect styli and other similar touch or force application objects. In addition, capacitance-based sensors allow transmission of about 90% of input pad light.

Surface acoustic wave-based input devices operate by emitting sound along the surface of the input pad and measuring the interaction of the application of the object with the sound. In addition, surface acoustic wave-based input devices allow transmission of 100% of input pad light, and don't require the applied object to comprise conductive properties. However, surface acoustic wave-based input devices are incapable of registering or detecting the application of hard and small objects, such as pen tips, and they are usually the most expensive of all the types of input devices. In addition, their accuracy and functionality is affected by surface contamination, such as water droplets.

Force-based input devices are configured to measure the location and magnitude of the forces applied to and transmitted by the input pad. Force-based input devices provide some advantages over the other types of input devices. For instance, they are typically very rugged and durable, meaning they are not easily damaged from drops or impact collisions. Indeed, the input pad (e.g., touch screen) can be a thick piece of transparent material, resistant to breakage, scratching and so forth. There are no interposed layers in the input pad that absorb, diffuse or reflect light, thus 100% of available input pad light can be transmitted. They are typically impervious to the accumulation of dirt, dust, oil, moisture or other foreign debris on the input pad.

Force-based input devices comprise one or more force sensors that are configured to measure the applied force. The force sensors can be operated with gloved fingers, bare fingers, styli, pens pencils or any object that can apply a force to the input pad. Despite their advantages, force-based input devices are typically too large and bulky to be used effectively in many touch screen applications. Additionally, conventional force-based input devices, as well as most other types of input devices, are capable of registering touch from only one direction, or in other words, on one side of the input pad, thereby limiting the force-based input device to monitor or screen-type applications.

One particular problem associated with force-based input devices deals with off-axis forces, which may be described as forces that are parallel to the touch surface or input portion. These are undesirable and tend to skew any results. Examples of means used to deal with and minimize these off-axis forces are ball joints, pointed supports, and springs. However, these are difficult and costly to make, and still do not work particularly well.

Another issue facing force-based input devices is constraint or over constraint of the input member as it is necessary to resolve the both the direction and location of application of the force.

Still another issue is vibration, which causes a problem because of the typical mass of the input member (e.g., the touch screen). Forces may be transmitted from the support to the input member when the support experiences vibration, which may cause inaccurate measurements and readings. Associated with this is inertia, wherein the baseline outputs of the sensors may depend on the orientation of the input member. The mass of the input member may produce different forces depending on its orientation. These different forces have been difficult to account for.

Infrared-based devices are operated by infrared radiation emitted about the surface of the input pad of the device. However, these are sensitive to debris, such as dirt, that affect their accuracy.

### SUMMARY OF THE INVENTION

In light of the problems and deficiencies inherent in the prior art, the present invention seeks to overcome these by providing a force-based input device that is responsive to an applied force (input) to determine the location and/or magnitude of the applied force as it relates to the input device, wherein the force-based input device reduces the effects off-axis forces, and wherein the device utilizes one or more modular sensing components operable with a fixed frame and a base support, these being independent from one another, wherein an input pad or input member is defined by one of the base support or fixed frame elements. The fixed frame and base support operate in conjunction with one another to receive and concentrate the forces, as applied to the input member, to a module relating these two components together, the module providing constraint in all directions, with constrain against off-axis forces being the greatest. The module comprises one or more sensing components having one or more sensors operable therewith. The applied forces, upon being received by the sensing component, are measured and various signals are output by the sensors to facilitate the determination of the location and/or magnitude of the applied force acting on the input member.

The module, comprising the sensing component(s), are configured to operably relate or join the fixed frame and the base support, as well as to constrain the movement or displacement of the input member relative to the fixed frame. In other words, unlike prior related force-based input devices, the sensing component itself functions to provide the constraint of the base support (typically including the input member) and the fixed frame with respect to one another. In one embodiment, one or more pairs of sensors, such as strain gages, are located on the sensing components in such a manner so as to sense the components of the applied forces that are normal (perpendicular) to the plane containing the sensing components, while being insensitive to any off-axis or non-normal forces.

The output signals of the sensors can be used to measure the location and/or magnitude of the forces being applied to the input member. Off-axis forces are minimized by providing at least one pair of sensors and locating these proximate an end of the sensing component and in or nearly in the same plane as the input or contact surface of the input member, as well as positioning the sensors so as to provide output of opposite polarity to cancel their respective responses to non-normal forces or forces in the plane of the sensors.

The constraining module functions to transmit the applied forces, or rather components thereof, between the base support and the fixed frame. The constraining module further functions to define the sensing component through various configurations. The input devices of the present invention are simple and easy to manufacture. In addition, a faulty sensor is easily replaced by being able to replace the module in which it is contained, rather than reworking the entire assembly.

In accordance with the invention as embodied and broadly described herein, the present invention resides in a force-based input device responsive to an applied force to determine a location of the applied force, the force-based input device comprising a fixed frame; a base support independent of and operable with the fixed frame and comprising an input pad adapted to receive the applied force and to displace relative to the fixed frame; a module adapted to constrain the base support and the fixed frame, the module comprising a sensing component adapted to receive resultant forces as distributed from the displacement of the input pad caused by the applied force, and to undergo a degree of deflection, the module being adapted to constrain movement of the base support and fixed frame in all directions with respect to one another, with constraint of off-axis forces being the greatest; and a sensor operable with the sensing component to output a signal corresponding to the degree of deflection of the sensing component, the signal facilitating the determination of a location of the applied force.

### BRIEF DESCRIPTION OF THE DRAWINGS

The present invention will become more fully apparent from the following description and appended claims, taken in conjunction with the accompanying drawings. Understanding that these drawings merely depict exemplary embodiments of the present invention they are, therefore, not to be considered limiting of its scope. It will be readily appreciated that the components of the present invention, as generally described and illustrated in the figures herein, could be arranged and designed in a wide variety of different configurations. Nonetheless, the invention will be described and explained with additional specificity and detail through the use of the accompanying drawings in which:

FIG. 1-A illustrates a cut-away side view of a force-based input device having a modular sensing element or component in accordance with a general exemplary embodiment of the present invention;

FIG. 1-B illustrates a top view of the modular sensing component used in the input device of FIG. 1-A;

FIG. 2 illustrates a force-based input device having a non-modular sensing component design, which design is being set forth to set forth similar concepts used in the present invention input devices;

FIG. 3 illustrates a perspective view of the force-based input device of FIG. 2 as coupled to a processing system used to perform the necessary processing steps to determine the location and/or magnitude of the applied force;

FIG. 4 illustrates a detailed view of a portion of the exemplary force-based input device of FIG. 2;

FIG. 5 illustrates a force-based input device having a non-modular sensing component in accordance with another exemplary embodiment;

FIG. 6 illustrates a force-based input device having a modular sensing component design in accordance with one exemplary embodiment of the present invention, wherein the sensing component is defined in the module by an aperture in and perimeter edge of the module;

FIG. 7 illustrates a top view of a force-based input device having a modular sensing component design in accordance with another exemplary embodiment of the present invention, wherein the sensing component is defined by a plurality of apertures formed in the module;

FIG. 8 illustrates a top view of a force-based input device having a modular sensing component design in accordance with another exemplary embodiment of the present invention, wherein the module comprises an s-shape, and wherein the sensing component is defined by a plurality of slots and corresponding edges formed in the module;

FIG. 9 illustrates a top view of a force-based input device having a modular sensing component design in accordance with another exemplary embodiment of the present invention, wherein the sensing component is also defined by a plurality of slots and corresponding edges formed in the module;

FIG. 10 illustrates a top view of a force-based input device having a modular sensing component design in accordance with another exemplary embodiment of the present invention, wherein the module is substantially I-shaped, and wherein the sensing component is defined by a plurality of slots and edges formed in the module;

FIG. 11 illustrates a top view of a force-based input device having a modular sensing component design in accordance with another exemplary embodiment of the present invention, wherein the sensing component is defined by a plurality of slots and a central opening formed in the module;

FIG. 12 illustrates a top view of a force-based input device having a modular sensing component design in accordance with another exemplary embodiment of the present invention, wherein the sensing component is formed by a plurality of slots and corresponding edges formed in the module;

FIG. 13-A illustrates a partial side view of a force-based input device having a modular sensing component design in accordance with another exemplary embodiment of the present invention, wherein the modular sensing component is indirectly coupled to the fixed frame and support components of the input device using spacers;

FIG. 13-B illustrates a top view of the modular sensing component of FIG. 13-A;

FIG. 14-A illustrates a partial side view of a force-based input device having a modular sensing component design in accordance with another exemplary embodiment of the present invention, wherein the modular sensing component is indirectly coupled to the fixed frame and support components of the input device using spacers;

FIG. 14-B illustrates a top view of the modular sensing component of FIG. 14-A;

FIG. 15-A illustrates a partial side view of a force-based input device having a modular sensing component design in accordance with another exemplary embodiment of the present invention, wherein the modular sensing component is indirectly coupled to the fixed frame and support components of the input device using spacers;

FIG. 15-B illustrates a top view of the modular sensing component of FIG. 15-A;

FIG. 16-A illustrates a partial side view of a force-based input device having a modular sensing component design in accordance with another exemplary embodiment of the present invention, wherein the modular sensing component is indirectly coupled to the fixed frame and support components of the input device using spacers;

FIG. 16-B illustrates a top view of the modular sensing component of FIG. 16-A;

FIG. 17-A illustrates a partial side view of a force-based input device having a modular sensing component design in accordance with another exemplary embodiment of the present invention, wherein the modular sensing component is indirectly coupled to the fixed frame and support components of the input device using spacers;

FIG. 17-B illustrates a top view of the modular sensing component of FIG. 17-A;

FIG. 18 illustrates partial top and side views of a force-based input device having a modular sensing component formed in accordance with another exemplary embodiment, wherein the module or the modular sensing component comprises a sensing component defined by one or more planar slots formed in the module;

FIG. 19 illustrates partial top and side views of a force-based input device having a modular sensing component formed in accordance with another exemplary embodiment wherein the module or the modular sensing component comprises a sensing component defined by one or more planar and orthogonal slots formed in the module; and

FIG. 20 illustrates partial top and side views of a force-based input device having a modular sensing component formed in accordance with another exemplary embodiment wherein the module or the modular sensing component comprises a sensing component defined by one or more orthogonal slots formed in the module.

### DETAILED DESCRIPTION OF EXEMPLARY EMBODIMENTS

The following detailed description of exemplary embodiments of the invention makes reference to the accompanying drawings, which form a part hereof and in which are shown, by way of illustration, exemplary embodiments in which the invention may be practiced. While these exemplary embodiments are described in sufficient detail to enable those skilled in the art to practice the invention, it should be understood that other embodiments may be realized and that various changes to the invention may be made without departing from the spirit and scope of the present invention. Thus, the following more detailed description of the embodiments of the present invention is not intended to limit the scope of the invention, as claimed, but is presented for purposes of illustration only and not limitation to describe the features and characteristics of the present invention, to set forth the best mode of operation of the invention, and to sufficiently enable one skilled in the art to practice the invention. Accordingly, the scope of the present invention is to be defined solely by the appended claims.

The following detailed description and exemplary embodiments of the invention will be best understood by reference to the accompanying drawings, wherein the elements and features of the invention are designated by numerals throughout.

Generally speaking, the present invention features a modular type of force-based input device configured to provide off-axis constraint of an input member with respect to a fixed frame operably related to the input member via one or more sensing components. As indicated above, the sensing component comprises a modular sensing component, such as an isolated modular beam configured to be separate and independent of the input member and the fixed frame.

It is intended to strategically form and locate or position the sensing components and the associated sensors with respect to the input member and the fixed frame to minimize sensitivity to off-axis forces (forces or force components not normal to the input member, and existing in the x-y direction (the z direction being normal to the input member)). The sensing components are intended to operably relate the input member and the fixed frame and to constrain these in all directions, while purposely functioning to primarily be sensitive to normal forces. This is a direct result of the configuration of the various elements of the force-based input device (e.g., the input member, the fixed frame, and the sensing components), which configuration also contemplates strategic location of the various sensors about the highest concentrated force or stress areas dictated by the geometry of the sensing components and the relationship with the input member and fixed frame. In some examples, coupling of the fixed frame and the input member to the sensing component provides high stress concentration in the sensing component that may be exploited. In other examples, stress concentration is achieved or enhanced that may be exploited by one or more apertures or cut away portions being formed in the sensing component. Several different designs and configurations of sensing components are discussed herein.

With respect to the sensors or sensor pairs, one sensor is intended to respond with a positive output and the other with a negative output. This is allows the sensors to respond to off-axis forces with the same output, and thus substantially cancel these out. The output from one of sensors is subtracted from the output of the other sensor so that the forces that are normal to the sensing component are enhanced and the off-axis forces are canceled.

The sensors in the various embodiments discussed herein may be comprised of any material that provides sufficient strength so as not to be deformed under the forces normally present within the sensing component in a particular application, that provides sufficient elastic deformation under the forces to be detected by the sensors, and that provides a repeatable response under environmental conditions (e.g., force, temperature, etc.). In the case of strain gages, this includes many metals (e.g., aluminum, steel, bronze, etc.), and a variety of polymers (e.g., polycarbonate). In the case of piezo sensors, much less elastic materials may be used, such as a thicker, tempered steel. Most sensors will be constructed of metals (due to the high ratio of elasticity to deformation) or polymers (due to inexpensive production costs).

Each of the advantages recited herein or apparent from the invention as taught herein are not meant to be limiting in any way. Indeed, one skilled in the art will appreciate that other advantages may be realized upon practicing the present invention.

The term “applied force,” as used herein, shall be understood to mean one or more forces applied in one or more directions to at least a point, but more appropriately an area or region, of a component of the force-based input device, such as the input member. The applied force or forces are to be understood to comprise input to the force-based input device. The applied forces may be applied in a rapid touch and release manner, in a more continuous manner, in a manner something between these, and any combinations thereof. Moreover, the applied force(s) may originate from a variety of sources, the most common being a person's touch. However, a variety of other sources are contemplated, such as various inanimate objects, including, but not limited to, pens, a styli, projectiles, etc. Applied forces result in one or more resultant forces within the various components of the force-based input device.

The term “isolated,” as used herein, shall be understood to describe the location of the sensing components or elements with respect to the input member and the fixed frame, and particularly the intended location of force transfer between these, as well as the intended location of concentration of resultant forces. Indeed, the sensing components or elements are “isolated” in that they provide an isolating function with respect to the resultant forces. The sensing elements effectively enable a defined and controlled path of resultant forces as transmitted between the input member and the fixed frame for the purpose of concentrating these for measurement.

The term “off-axis constraint,” as used herein, shall be understood to mean the constraint of the input member with respect to the fixed frame in an off-axis direction (i.e., lateral or not normal or parallel to the plane of the input member, or in the x-y directions, the z direction being normal or perpendicular to the input member) to a sufficient degree so as to enable the sensing components to sense those components of the applied forces that are normal (perpendicular) to the plane containing the sensing components, while being insensitive to any non-normal or off-axis forces respective of the same plane.

The term “resultant forces,” as used herein, shall be understood to mean those forces acting within the several components of the force-based input device (e.g., the input member, the fixed frame, the sensing elements, etc.) that correspond to any applied forces acting on the input member. It is these resultant forces that are transferred between the input member and the fixed frame and that are concentrating in and measured by the sensing elements. Resultant forces may induce strain, stress, and any other measurable characteristics thereof.

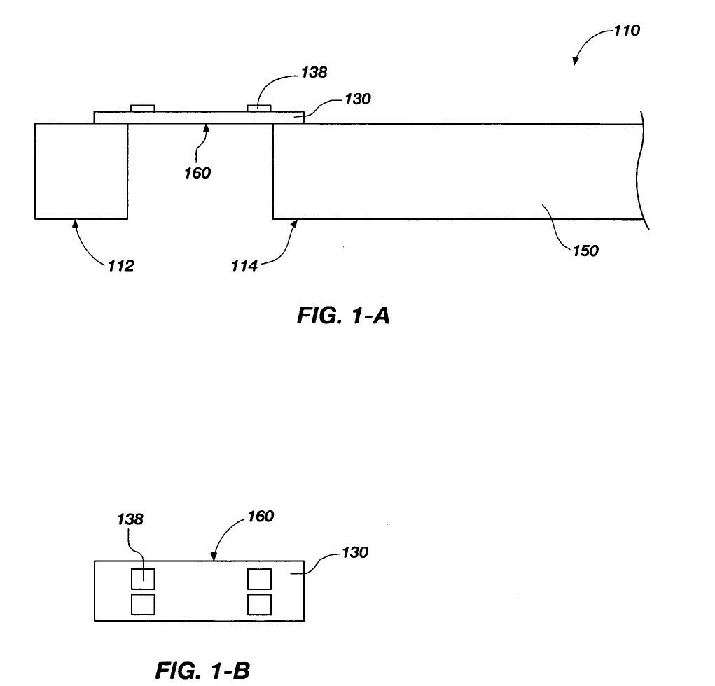

With reference to FIGS. 1-A and 1-B, illustrated is a general representation of an exemplary force-based input device having a modular sensing component. As shown, the force-based input device 110 comprises a fixed frame 112 operably related to the base support 114 (having or defining an input pad 150) via a module or modular sensing component 130, which may be described as an isolated modular beam, that is coupled between the base support 114 and the fixed frame 112, each of which are separate and independent structures from one another. The fixed frame 112 and the base support 114 define a gap or space therebetween across which a module 160, incorporating or being the sensing component 130 (modular beam), extends. The module 160 functions to constrain the support base 114 with respect to the fixed frame 112 in all directions, being particularly stiff to provide constraint against off-axis forces. The sensing component 130 is shown as comprising two pairs of sensors 138 positioned about areas of intended high stress concentration within the sensing component 130. These general concepts are discussed in greater detail below with respect to more specific embodiments.

### Illustrative Force-Based Input Device Having a Non-Modular Sensing Component

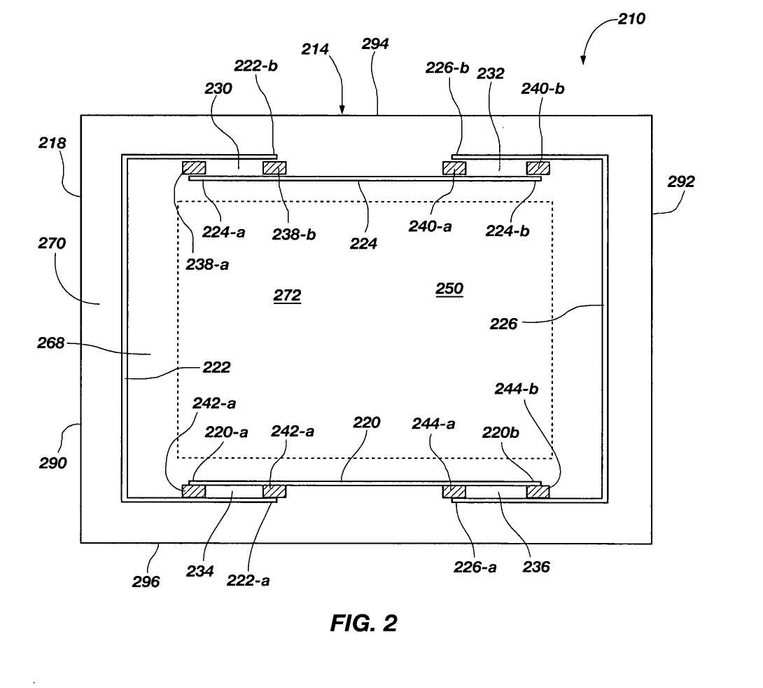

An exemplary force-based input device having a non-modular sensing component is discussed below in FIGS. 2-5. This embodiment is similar and related to the force-based input devices described in related, co-pending U.S. patent application Ser. No. 11/402,694, filed Apr. 11, 2006, and entitled, “Force-based Input Device,” which is incorporated by reference in its entirety herein. A discussion of such a force-based input device that comprises integrally formed, non-modular sensing components is being set forth for the purpose of illustrating similar concepts and technology upon which the present invention force-based input device having a modular sensing element may be based. One skilled in the art will recognize the relationship between these.

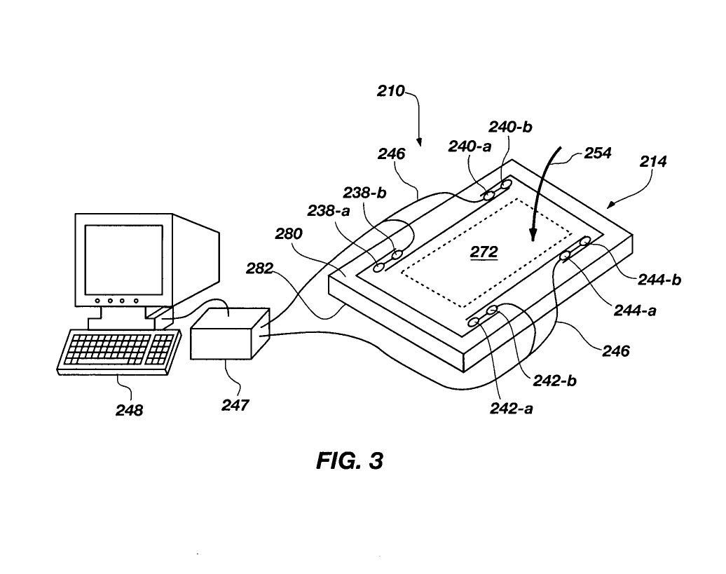

With reference to FIGS. 2 and 3, illustrated is a force-based input device 210 in accordance with one exemplary embodiment. The exemplary input device 210 is shown as comprising a base support 214 having an outer periphery 218. A plurality of apertures 220, 222, 224, and 226 can be formed in the base support 214 within the periphery 218. The apertures 220, 222, 224, and 226 can be located along the periphery 218 and can circumscribe and define a substantially rectangular input member 250, delineated by dashed lines in FIG. 2, that functions as the force receiving and sensing portion of the input device 210. The plurality of apertures can also define a plurality of isolated beams, shown as isolated beams 230, 232, 234, and 236, located between the periphery 218 and the corners of the input member 250, parallel to the sides of the input member 250.

Various sensors may be disposed on or about each isolated beam, respectively, particularly at areas or regions of high concentrated stress. As shown, each isolated beam 230, 232, 234, and 236 comprises one or a pair of sensors, shown as sensors 238-a and 238-b located on and operable with isolated beam 230, sensors 240-a and 240-b located on isolated beam 232, sensors 242-a and 242-b located on and operable with isolated beam 234, and sensors 244-a and 244-b located on and operable with isolated beam 236. The particular sensors are configured to detect and measure the force applied to the input member 250, or a resulting characteristic thereof (e.g., strain). In addition, the sensors are each configured to output an electronic signal, comprising sensor data, through a transmission device 246 attached or otherwise related to the sensors, which signal corresponds to the applied force as detected by the sensors. The location of the sensors about the several sensing components allows the individual sensors within a respective pair to output signals having opposite polarity to cancel their respective response to off-axis forces or forces in the plane of the sensors.

In one exemplary embodiment, the sensors each comprise a strain gauge configured to measure the strain within or across each of the respective isolated beams. Moreover, although each isolated beam is shown comprising two sensors located or disposed thereon, the configuration is not limited to this. It is contemplated that one, two or more than two sensors may be disposed along one or more surfaces of each of the isolated beams depending upon system constraints and other factors. In addition, it is contemplated that the isolated beams themselves may be configured as sensors (e.g., as in the case of piezoelectric beams).

The transmission device 246 (see FIG. 3) is configured to carry the sensors' output signal and sensor data to one or more signal processing devices, shown as signal processing device 247, wherein the signal processing devices function to process the signal in one or more ways for one or more purposes. For example, the signal processing devices may comprise analog signal processors, such as amplifiers, filters, and analog-to-digital converters. In addition, the signal processing devices may comprise a micro-computer processor that feeds the processed signal to a computer 248, as shown in FIG. 3. Or, the signal processing device may comprise the computer 248, itself. Still further, any combination of these and other types of signal processing devices may be incorporated and utilized. Typical signal processing devices and methods are known in the art and are therefore not specifically described herein.

Processing means and methods employed by the signal processing device for processing the signal for one or more purposes, such as to determine the coordinates or location or magnitude of a force applied to the force-based touch pad, are also known in the art. Various processing means and methods are discussed in further detail below.

With reference again to FIGS. 2 and 3, the base support 214 is shown comprising a substantially flat, or planar, pad or plate. The base support 214 can have an outer mounting portion 270 and an inner mounting portion 268 that can lie essentially within the same plane in a static condition. The outer mounting portion 270 can be located between the periphery 218 and the apertures 220, 222, 224, and 226. The inner mounting portion 268 can be located between the input member 250 and the apertures 220, 222, 224, and 226. The isolated beams 230, 232, 234, and 236 can operably connect the inner mounting portion 268 with the outer mounting portion 270. The outer mounting portion 270 can be mounted to any suitably stationary mounting structure configured to support the input device 210. The input member 250 can be a separate structure mounted to the inner mounting portion 268, or it may be configured to be an integral component that is formed integrally with the inner mounting portion 268. In the embodiment where the input member is a separate structure, one or more components of the input member can be configured to be removable from the inner mounting portion. For example, the input member 250 may comprise the combination of a large aperture formed in the base support 214, and a removable force panel configured to be inserted and supported within the aperture, which force panel may be configured to receive the applied force from either direction.

The base support 214 can be formed of any suitably inelastic material, such as a metal, like aluminum or steel, or it can be formed of a suitably inelastic, hardened polymer material, as are known in the art. In addition, the base support 214 may be formed of glass, ceramics, and other similar materials. The base support 214 can be shaped and configured to fit within any type of suitable interface application.

It is noted that the performance of the input device 210 may be dependent upon the stiffness of the mounting portion, such as the outer mounting portion, of the base support 214. As such, the base support 214, or at least appropriate portions thereof, should be made to comprise suitable rigidity or stiffness so as to enable the input device to function properly. Alternatively, instead of making the base support 214 stiff, the base support 214, or at least a suitable portion thereof, may be attached to some type of rigid support. It is recognized that suitable rigidity functions to facilitate more accurate readings.

The input member 250 can be a substantially flat, or planar, pad or plate and can lie within the same plane as the base support 214. The input member 250 can be circumscribed by the apertures 220, 222, 224, and 226. The input member 250 is configured to displace with respect to the fixed mounting portions in response to various stresses induced in the input member 250 resulting from application of a force acting on the input member 250. The input member 250 is further configured to transmit the resultant forces induced by the applied force to the inner mounting portion 268 and eventually to the isolated beams 230, 232, 234, and 236 where resulting strains in the isolated beams are induced and measured by the one or more sensors.

The base support 214 and input member 250 can have a first side 280 and a second side 282. The technology described herein advantageously provides for the transfer of force to either the first or second sides 280 and 282 of the input member 250, and subsequently to the sensing components or isolated beams. The input member 250 may be configured to displace out of the plane of the base support 214 in either direction in response to the applied force.

The input member 250 can be formed of any suitably rigid material that can transfer, or transmit the applied force to the sensing components or isolated beams. Such a material can be metal, glass, or a hardened polymer, as are known in the art.

The isolated beams 230, 232, 234, and 236 can be formed in the base support 214, and may be defined by the plurality of apertures 220, 222, 224, and 226. The isolated beams 230, 232, 234, and 236 can lie essentially in the same plane as the base support 124 and the input member 250 when in a static condition. In some embodiments, the apertures 220, 222, 224, and 226 may be configured to extend all the way through the base support 214. For example, the apertures 220, 222, 224, and 226 can be through slots or holes. In other embodiments, the isolated beams 230, 232, 234 and 236 may be configured to extend only partially through the base support 214.

As specifically illustrated in FIG. 2, the isolated beam 230 can be formed or defined by the apertures 222 and 224. Aperture 222 can extend along a portion of the periphery 228 and have two ends 222-a and 222-b. The aperture 224 can extend along another portion of the periphery and have two ends 224-a and 224-b. Portions of the two apertures 222 and 224 can overlap and extend along a common portion of the periphery 218 where one end 222-b of aperture 222 overlaps an end 224-a of aperture 224. The two ends 222-b and 224-a, and the portions of the apertures 222 and 224 that extend along the common portion of the periphery 218, can be spaced apart on the base support 214 a pre-determined distance. The portion of the aperture 222 that extends along the common portion of the periphery 218 can be closer to the periphery 218 than the portion of the aperture 224 that extends along the common portion of the periphery 218. The area of the base support 214 between the aperture 222 and the aperture 224, and between the end 222-b and the end 224-a, can define the isolated beam 230.

The isolated beams 232, 234, and 236 can be similarly formed and defined as described above for isolated beam 230. Isolated beam 232 can be formed by the area of the base support 214 between the apertures 224 and 226, and between the ends 224-b and 226-b, respectively. Isolated beam 234 can be formed by the area of the base support 214 between the apertures 220 and 222, and between the ends 220-a and 222-b. Isolated beam 236 can be formed by the area of the base support 214 between the apertures 220 and 226, and between the ends 220-b and 226-a. Thus, all of the isolated beams can be defined by the various apertures formed within the base support 214. In addition, the isolated beams may be configured to lie in the same plane as the plane of the input member 250 and base support 214, as noted above.

The plurality of apertures 220, 222, 224, and 226 can nest within or overlap in an x or y direction, wherein apertures 222 and 226 extend along the sides 290 and 292, respectively, of the rectangular base support 214, and can turn perpendicular to the short sides 290 and 292 and extend along at least a portion of the sides 294 and 296 of the base support 214. Apertures 220 and 224 can be located along a portion of the sides 296 and 294, respectively, of the base support 214 and closer to the input member 250 than apertures 222 and 226. Thus, apertures 220 and 224 can be located or contained within apertures 222 and 226. Stated differently, the apertures may each comprise a segment that overlaps and runs parallel to a segment of another aperture to define an isolated beam, thus allowing the isolated beams to comprise any desired length.

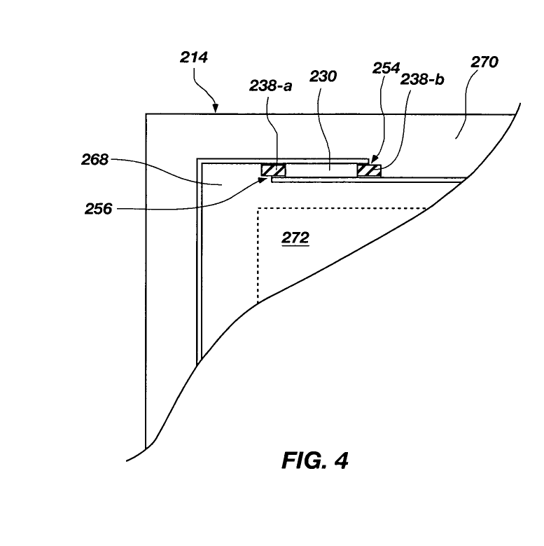

As illustrated in FIG. 4, the isolated beam 230 may comprise an outer or periphery juncture 254, formed with the outer mounting portion 270, and an inner juncture 256, formed with the inner mounting portion 268 of the base support 214. The inner juncture 256 and outer juncture 254 are configured to receive and concentrate the stresses induced on the base support 214 by the applied force to the isolated beam 230 by deflecting or bending in opposite directions. Upon the transfer of a force to the input member 250 from the projected contacting element (not shown), at least a portion of the resultant forces are transmitted through or from the input member 250 to the isolated beam 230 as a result of the configuration of the isolated beam 230, and specifically the inner and outer junctures 254 and 256, in relation to the input member 250 and the inner mounting portion 268. For example, when a force is transferred to the input member 250 from the contacting element via the transfer element(s), the input member 250 displaces and induces stresses in the input member 250. A portion of these stresses can be transmitted from the input member 250 to the inner mounting portion 268, and ultimately to the isolated beam 230 where sensors 238-a and 238-b function to detect and measure the strain within the isolated beam 230. It is this measured characteristic or attribute of the applied force that the sensor data comprises. Although not shown in FIG. 4, each of the other isolated beams (see FIGS. 2 and 3) discussed above function in a similar manner.

With reference again to FIGS. 2 and 3, upon receiving the forces or stresses, the isolated beams 230, 232, 234, and 236 are configured to deflect or bend in response to the displacement of the input member 250 and in response to the force being applied to the input member 250. Thus, the force as applied to the input member 250 and the resultant stresses induced in the input member 250 can be directed to and concentrated in the isolated beams 230, 232, 234, and 236. The concentrated stresses can result in deflection of the isolated beam 230, 232, 234, and 236 segments, and the strain resulting from this deflection can be measured by the sensors 238-a and 238-b, 240-a and 240-b, 242-a and 242-b, and 244-a and 244-b, respectively.

The sensors 238-a and 238-b, 240-a and 240-b, 242-a and 242-b, and 244-a and 244-b can be located along each isolated beam 230, 232, 234, and 236, respectively, essentially in the same plane as the base support 214 and the input member 250 when in a static condition. Specifically, as shown in FIGS. 2 and 3, a sensor can be located at or proximate an end of each isolated beam. Thus, a sensor 238-a can be located on isolated beam 230 near the end 224-a of the aperture 224. Similarly, another sensor 238-b can be located on the isolated beam 230 near the end 222-b of the aperture 222. The sensor 240-a can be located on isolated beam 232 near aperture end 226-b of aperture 226, and sensor 240-b can be located on isolated beam 232 near aperture end 224-b of aperture 224. The sensor 242-a can be located on isolated beam 234 near aperture end 220-b of aperture 220, and sensor 242-b can be located on isolated beam 234 near aperture end 222-b of aperture 222. The sensor 244-a can be located on isolated beam 236 near aperture end 226-a of aperture 226, and sensor 244-b can be located on isolated beam 236 near aperture end 220-b of aperture 220.

The sensors 238-a and 238-b, 240-a and 240-b, 242-a and 242-b, and 244-a and 244-b can also be located along each isolated beam 230, 232, 234, and 236 in a different plane than the base support 214 and the input member 250 when in a static condition. The sensors 238-a and 238-b, 240-a and 240-b, 242-a and 242-b, and 244-a and 244-b do not necessarily have to be in the same plane as the input member 250, but preferably lie within the same plane with respect to one another. Indeed, a plane containing all the sensors 238-a and 238-b, 240-a and 240-b, 242-a and 242-b, and 244-a and 244-b is hereinafter referred to as the sensor or sensing plane. For example, an isolated beam having a side in the same plane as the input member 250, and a side in an offset plane from the input member 250 can have the sensor plane located on the side that is in the same plane as the input member 250, or can have the sensor plane located on the side that is offset to the plane of the input member 250. In either case, the sensors are configured to lie within a common sensor plane.

The sensors 238-a and 238-b, 240-a and 240-b, 242-a and 242-b, and 244-a and 244-b are configured to measure the deflection in the isolated beams 230, 232, 234, and 236, respectively, caused by the applied force acting on the input member 250 as transferred thereto from the contacting element via the transfer element(s). The sensors 238-a and 238-b, 240-a and 240-b, 242-a and 242-b, and 244-a and 244-b can be any type of sensor capable of measuring properties related to displacement of the isolated beams 230, 232, 234, and 236. For example, the sensors can be strain gages, capacitance gages, liquid level gages, laser level gages, piezo sensors or any suitable sensor as is known in the art. The sensors 238-a and 238-b, 240-a and 240-b, 242-a and 242-b, and 244-a and 244-b can generate an electrical signal comprising sensor data corresponding to the displacement of the isolated beams 230, 232, 234, and 236. The electrical signal can be transmitted from the sensors 238-a and 238-b, 240-a and 240-b, 242-a and 242-b, and 244-a and 244-b via one or more transmission means.

The transmission means may comprise a wired or wireless transmission means, including for example, electrical wires 246, such as those shown in FIG. 3, a radio transmitter, optical communication devices, and/or others as known in the art. The transmission means is configured to carry the signal output by each of the various sensors to a signal processor or signal processing means, shown as signal processor 247, configured to receive and analyze the electrical signal and corresponding sensor data to determine the location and/or magnitude of the applied force on the projected contacting element and input member 250. The processing means and analysis methods can be any known in the art.

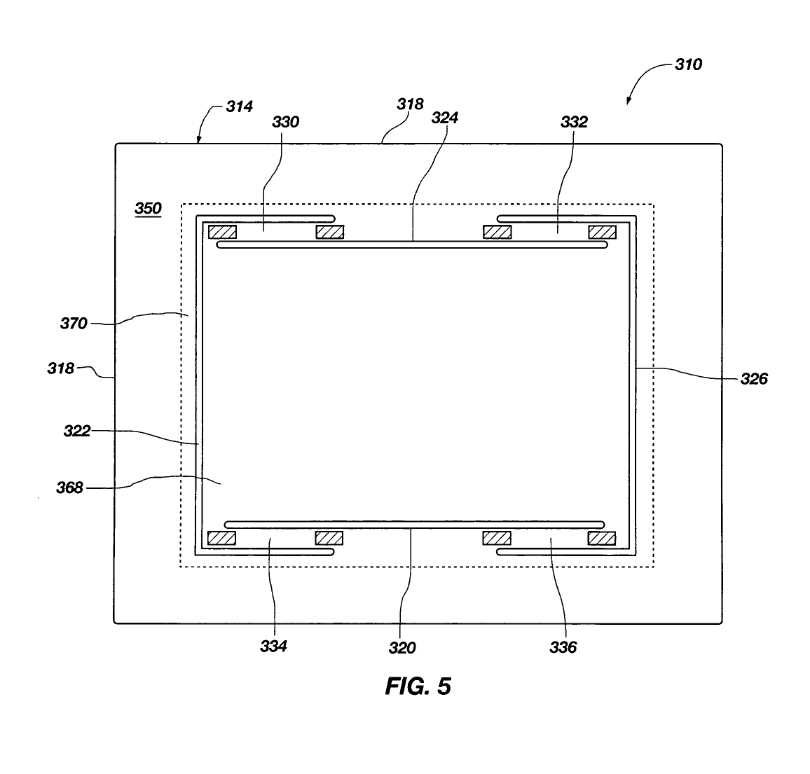

FIG. 5 illustrates a force-based input device 310 in accordance with still another exemplary embodiment. In this particular embodiment, the input device 310 comprises a base support 314 having an outer periphery 318. A plurality of apertures 320, 222, 324, and 326 can be formed in the base support 314 within the periphery 318. The apertures 320, 322, 324, and 326 can be located along the periphery 318 and can define a substantially rectangular input member 350 formed about the periphery 318, as delineated by dashed lines in FIG. 5. The plurality of apertures can also define a plurality of isolated beams, 330, 332, 334, and 336, near the corners of, and parallel to the sides of the input member 350, each of which may be operable with one or more sensors as shown.

The base support 314 is shown comprising a substantially flat, or planar, pad or plate. The base support 314 can have an outer mounting portion 370 and an inner mounting portion 368 that can lie essentially within the same plane in a static condition. The outer mounting portion 370 can be located between the periphery 318 and the apertures 320, 322, 324, and 326, as well as between the input pad 350 and the various apertures. In other words, the input pad 350 may be configured to circumscribe the outer mounting portion 370. The inner mounting portion 368 can be located inside of the various apertures 320, 322, 324, and 326, or in other words be circumscribed by the various apertures 320, 322, 324, and 326. The isolated beams 330, 332, 334, and 336 can connect the inner mounting portion 368 with the outer mounting portion 370. The outer mounting portion 370 can be mounted to any suitably stationary mounting structure configured to support the sensing device 310. The input member 350 can be a separate structure mounted to the outer mounting portion 370, or it may be configured to be an integral component that is formed integrally with the outer mounting portion 370.

The input member 350, as supported about and integral with the periphery 318 is configured to displace in response to various stresses induced in the input member 350 resulting from application of a force acting on the input member 350. The input member 350 is further configured to transmit the stresses induced by the applied force to the outer mounting portion 370 and eventually to the isolated beams 330, 332, 334, and 336 where resulting strains in the isolated beams are induced and measured by the one or more sensors in a similar manner as described above with respect to the embodiment shown in FIG. 3.

Essentially, the input device 310 illustrated in FIG. 5 is similar to that shown in FIG. 2, except that the input member 350 of FIG. 5 is located about the perimeter or periphery of the input device with the inner and outer mounting portions being positioned inside or interior to the input member 350. In other words, the input device of FIG. 5 may be considered to comprise a structural configuration that is the inverse of the input device shown in FIG. 2. This particular embodiment is intended to illustrate that the input device may broadly be described as comprising a first structural element supported in a fixed position (fixed frame), and a second structural element operable with the first structural element, wherein the second structural element is dynamically supported to be movable with respect to the first structural element to define a sensing portion configured to displace under an applied force (input member).

It is noted that the above description with respect to FIGS. 2-5 are intended to comprise general concepts, all or some of which may be applicable and incorporated into the several other designs or embodiments discussed. This will be apparent to one skilled in the art, and embodiments not specifically describing a like features and/or like functions should not be considered to be limited in any way.

### Force-Based Input Devices Having Modular Sensing Components

Various exemplary force-based input devices utilizing a modular sensing element or component are discussed below. Although different, and although comprising modular sensing components, these embodiments are similar and related in many respects to the non-modular type force-based input devices described above.

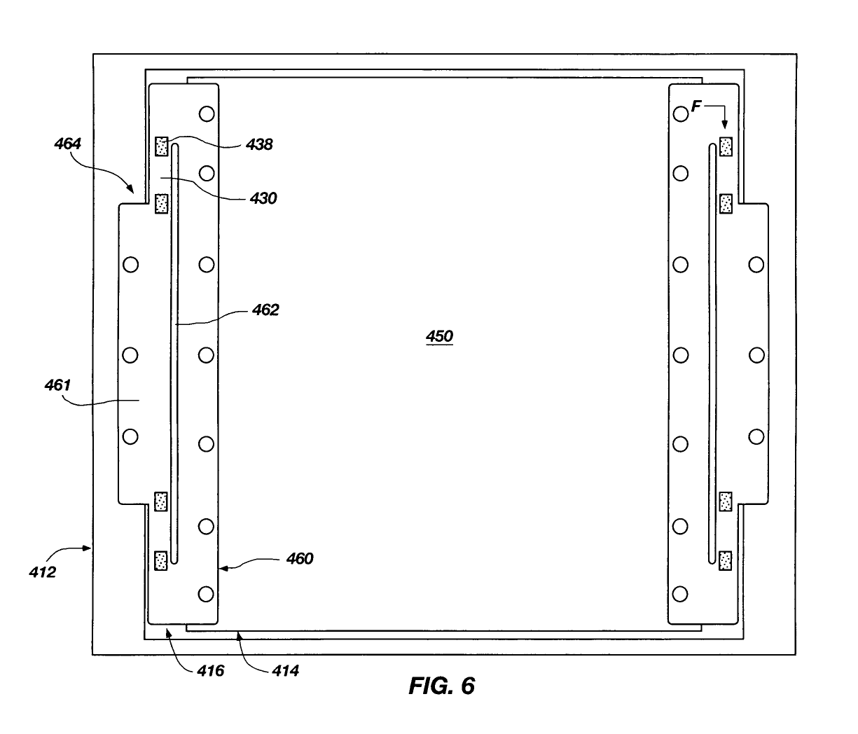

With respect to FIG. 6, illustrated is a force-based input device utilizing a modular sensing component, in accordance with one exemplary embodiment of the present invention. As shown, the input device 410 comprises a fixed frame 412 operable with a base support 414 having an input member 450, wherein the fixed frame 412 and base support 414 are separate and independent structures from one another. Stated differently, the fixed frame 412 and the base support 414 are not integrally formed with or related to one another.

Fixed frame 412 and base support 414 are operably related to one another via a module 460 configured to couple to the fixed frame 412 and also the base support 414, and to span the gap 416 formed between the fixed frame 412 and the base support 414. Although not described, the input device 410 is shown as comprising two modules. Each of these function in a similar manner. The module 460 functions to provide, function as, or facilitate the defining of one or more sensing components rather than these being integrally formed with the fixed frame 412 and/or the base support 414. For example, in the embodiment shown, the module 460 further comprises a sensing component 430 (in the form of an isolated beam) defined by an aperture 462, an edge of the module 460 and channel 464. The module 460 comprises an extension portion 461 that overlaps the fixed frame 412 at a location proximate the sensing component 430 and the sensor 438, thus strategically facilitating the concentration of forces at the sensing component. Each of the other sensing components function in a similar manner.

The sensing component 430 is oriented and positioned about the gap 416, and the module 460 is appropriately positioned and mounted, so as to prevent the sensing component from contacting either the fixed frame 412 or the base support 414. As the sensing component 430 is not integrally formed with either of the fixed frame 412 or the base support 414, any contact with either of these would work against the intended function of configuring the input device 410 such that forces resultant from an applied force about the input pad 450 are concentrated at the sensing component 430.

Similar to other sensing components described herein, the sensing component 430 comprises at least one pair of sensors 438 operable therewith to measure the resulting forces, or a characteristic thereof, transmitted to the sensing component 430. The pair of sensors 438 may be positioned anywhere along a region or area of highly concentrated stresses, which will typically be proximate the ends of the sensing component 430. In this respect, the sensors 438 may respond to the resultant forces and provide output of opposite polarity.

The module 460 further functions to facilitate the transfer of resulting forces between the base support 414 and the fixed frame 412 upon displacement of the input member 450, with the resulting forces purposely being directed to and concentrated along the sensing component 430. Furthermore, the module 460, with its sensing components, function to constrain the base support 412 and the input member 450 with respect to the fixed frame 412 against off-axis movement (e.g., movement in the lateral direction) from off-axis forces, so as to reduce sensitivity of the sensors 438 to non-normal or off-axis force components as measured from a plane containing the sensing components 430. Indeed, the module 460 and the sensing components 430 themselves function to provide lateral constraint.

The module of the present invention may comprise many different sizes, shapes and configurations, some of which are shown in the drawings and set forth herein. The module may be made from different types of materials (e.g., metal, plastic, composite, etc.), but is intended to comprise a substantially rigid or stiff makeup.

The modules may be coupled or attached to the fixed frame 412 and the input member 450 using any known attachment means, such as screws, bolts, adhesives, etc. In addition, it is contemplated that the modules may be inserted into corresponding grooves, recesses or spaces formed in the surfaces of the fixed frame 412 and the base support 414. This may help cut decrease the profile of the overall input device, as well as facilitate a more coplanar relationship between the sensors and the base support 414.

It is noted herein that the fixed frame and the input member, as described above and with respect to this embodiment, may trade functions. In other words, what was described as the fixed frame 412 may be made to function as the input member. Likewise, what was described as the input member 450 (together with the base support 414) may be made to function as the fixed frame. The present invention contemplates an embodiment having an internal fixed frame and an outer movable input member, with the module connecting and constraining these with respect to one another. As such, the input device shown in FIG. 6 and discussed above is not intended to be limiting in any way, and particularly in this respect.

The module and modular sensor component concept provides many advantages. For instance, the module is simple and cheap to manufacture while providing the same functionality as other non-modular, integrated designs, such as those discussed above with respect to FIGS. 2-5. Another advantage centers around maintenance and/or repair. If one sensor or module is not working properly or needs to be replaced, that particular module may be temporarily removed and repaired, or replaced with a new module, without having to destroy or replace the entire input device. Other advantages will be apparent to those skilled in the art.

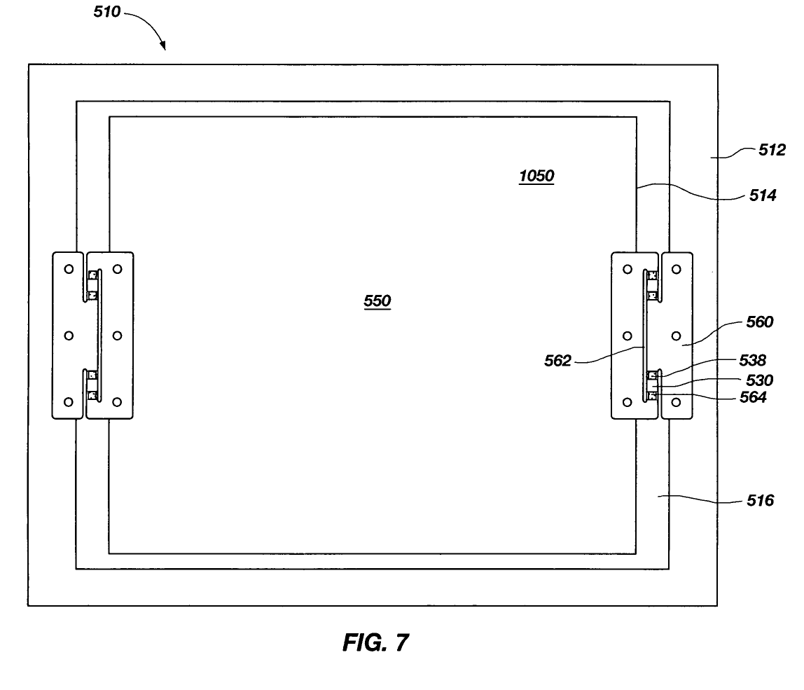

FIGS. 7-20 set forth additional exemplary force-based input devices having or utilizing a module and a modular sensing component configuration. As such, much of the discussion above with respect to FIG. 6 is applicable to these embodiments, and is therefore intended to be incorporated therein, respectively, where appropriate as recognized by those skilled in the art. Embodiments not specifically describing like features and/or like functions should not be considered to be limited in any way.

With reference to FIG. 7, illustrated is a force-based input device utilizing a modular sensing component, in accordance with another exemplary embodiment of the present invention. As shown, the force-based input device 510 comprises a fixed frame 512 operably related to a base support 514 having an input member 550. The fixed frame 512 is separate and independent of the base support 514, with the two defining a gap 516 therebetween.

Disposed about the gap 516 and operably coupling the fixed frame 512 to the input member 550 is a module 560 having at least one sensing component 530 a part thereof. The module is mounted on one side to the base support 514, and on the other side to the fixed frame 512. Unlike the embodiment discussed above and shown in FIG. 6, the sensing component 530 is defined by apertures 562 and 564, each formed in module 560.

The input device 510 further comprises a pair of sensors 538 disposed about and operable with the sensing component 530 and the module 560. The module 560 may be located anywhere along the gap 516 formed between the fixed frame 512 and the base support 514. It should be noted that again, the sensing component 530 is positioned about the space or gap 516, so as to be prohibited from contacting either the fixed frame 512 or the base support 514 during operation. This helps to ensure that the resultant forces from an applied force are properly transferred to and concentrated in the sensing component 530.

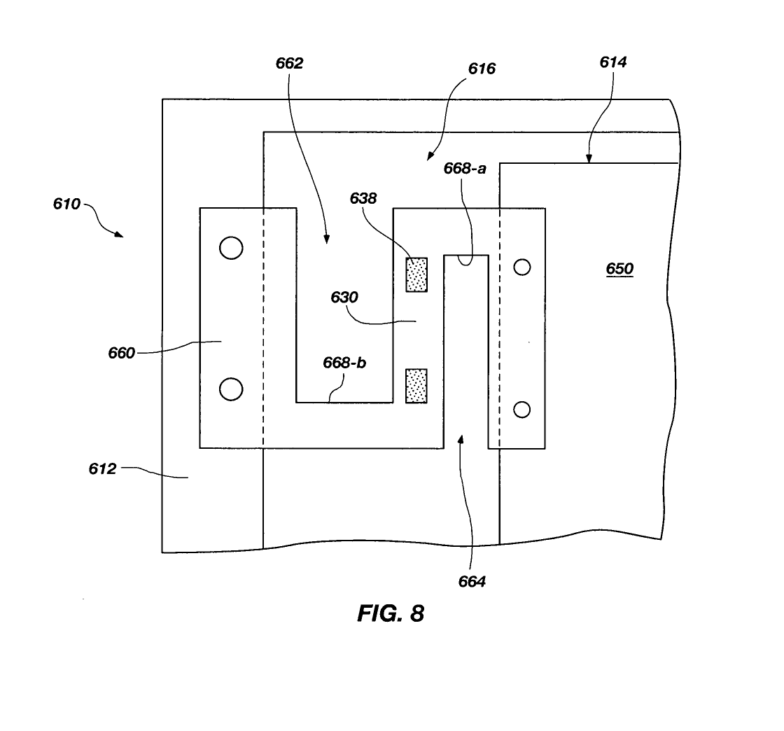

With reference to FIG. 8, illustrated is a force-based input device utilizing a modular sensing component, in accordance with another exemplary embodiment of the present invention. As shown, the force-based input device 610 comprises a fixed frame 612 operably related to a base support 614 having an input member 650. The fixed frame 612 is separate and independent of the base support 612 and input member 650, with the two defining a gap 616 therebetween.

Disposed about the gap 616 and operably coupling the fixed frame 612 to the base support is a module 660 having an s-shape. Formed within the module 660 (being an integral component of the module as in the preceding embodiments) is at least one sensing component 630 configured to be positioned about the gap 616, which sensing component 630 further comprises a pair of sensors 638 disposed about and operable therewith. In this particular embodiment, the sensing component 630 is defined by a plurality of channels 662 and 664 formed in the module 660. These channels may comprise different sizes and/or configurations as needed. The respective sensors are shown as being positioned near or in close proximity to respective axes extending along edges 668-a and 668-b. With the sensors at these locations they are positioned at the region of greatest stress concentration within the sensing component 630. Although not shown, it is contemplated that the force-based input device comprise two or more similar modules positioned about the input device, such as on opposing sides or at the corners.

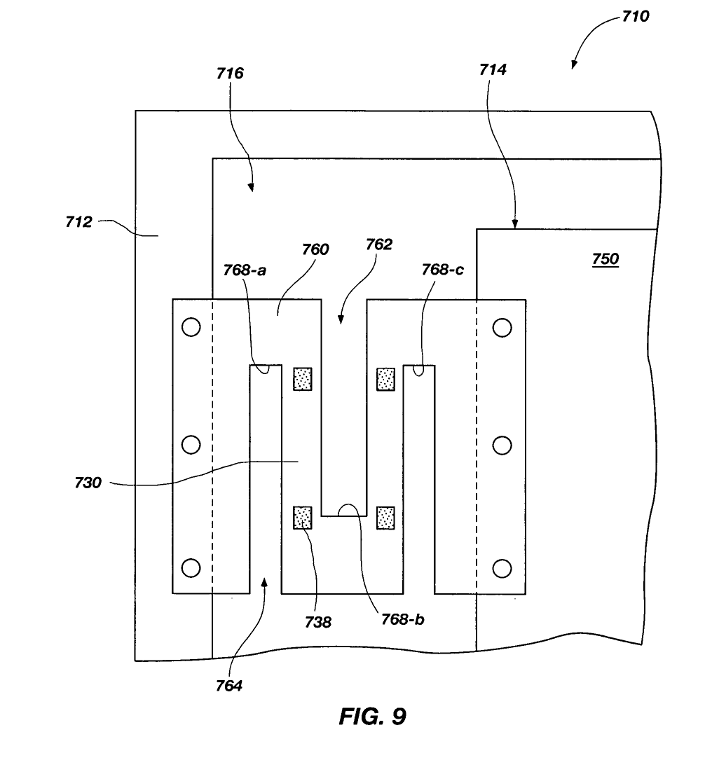

With reference to FIG. 9, illustrated is a force-based input device utilizing a modular sensing component, in accordance with another exemplary embodiment of the present invention. As shown, the force-based input device 710 comprises a fixed frame 712 operably related to a base support 712 having an input member 750. The fixed frame 712 is separate and independent of the base support 712, with the two defining a gap 716 therebetween.

Disposed about the gap 716 and operably coupling the fixed frame 712 to the base support 712 is a module 760 having at least one sensing component 730 formed thereon, wherein the sensing component 730 further comprises a pair of sensors 738 operable therewith. In this particular embodiment, the module 760 comprises two sensing components, each with a pair of sensors. The sensing component 730 is formed or defined by channels 762 and 764 formed in the module 760. The second sensing component is likewise formed and defined. The respective sensors are shown as being positioned bout respective axes extending along respective edges, such as edges 768-a, 768-b and 768-c. With the sensors at these locations they are positioned at the region of greatest stress concentration within the sensing component 730.

Again, it is contemplated that the force-based input device comprise two or more similar modules positioned about the input device.

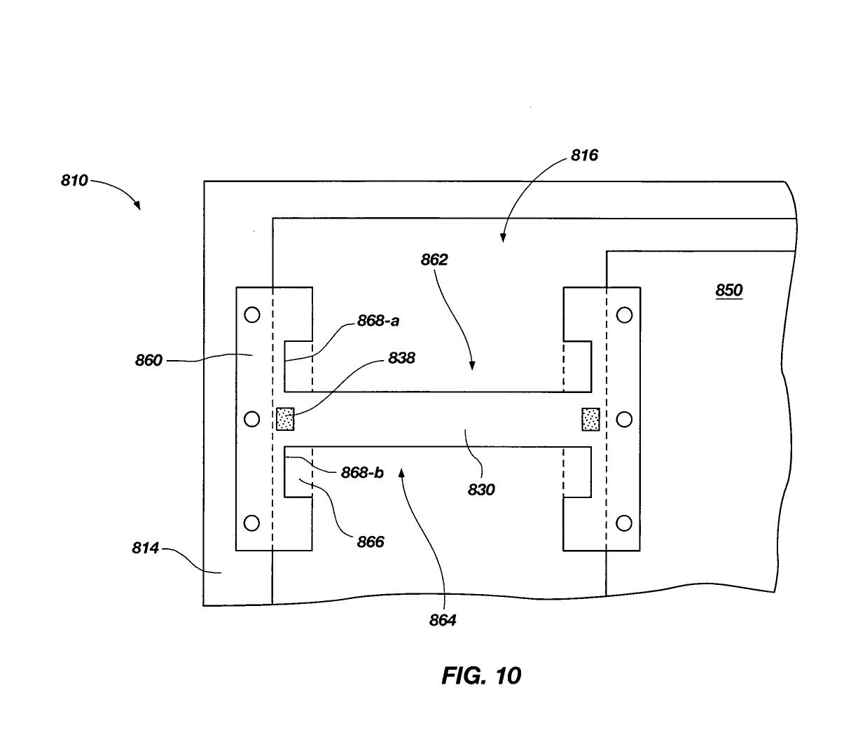

With reference to FIG. 10, illustrated is a force-based input device utilizing a modular sensing component, in accordance with another exemplary embodiment of the present invention. As shown, the force-based input device 810 comprises a fixed frame 812 operably related to a base support 812 having an input member 850. The fixed frame 812 is separate and independent of the base support 812, with the two defining a gap 816 therebetween.

Disposed about the gap 816 and operably coupling the fixed frame 812 to the input member 850 is a module 860 having at least one sensing component 830 formed thereon, wherein the sensing component 830 further comprises a pair of sensors 838 disposed about and operable therewith. In this particular embodiment, the sensing component 830 is formed and defined by channels 862 and 864 being formed in the module 860 as shown. The module 860 may further comprise slots 866 formed therein to enhance and improve the concentration of resultant forces and stresses about the sensing component 830. The sensors 838 are shown as being positioned near the ends of the module 860, about an axis extending along and between edges 868-a and 868-b. With the sensors 838 at these locations they are positioned at the region of greatest stress concentration within the sensing component 830.

Again, it is intended that the force-based input device comprise two or more similar modules positioned about the input device.

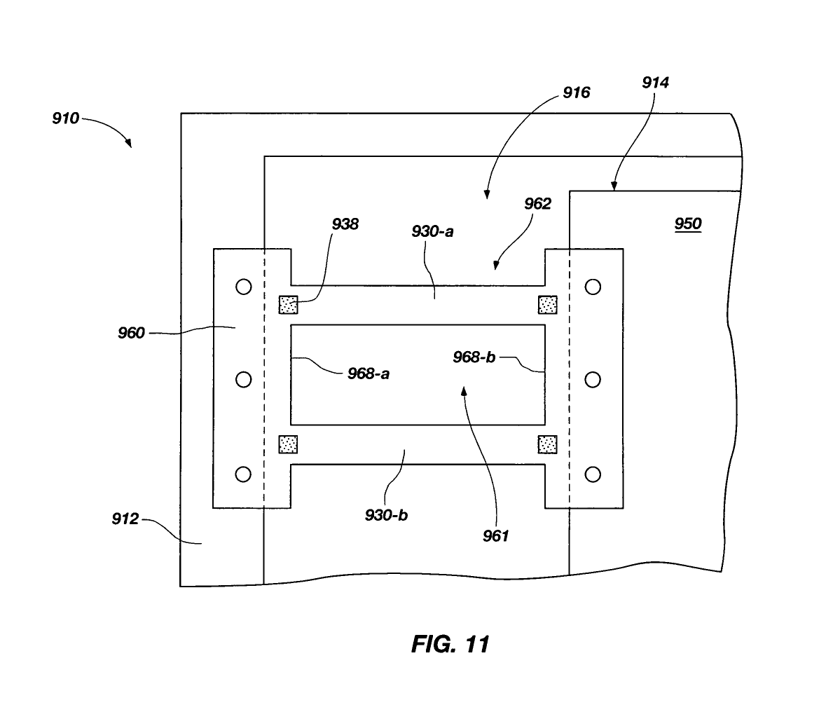

With reference to FIG. 11, illustrated is a force-based input device utilizing a modular sensing component, in accordance with another exemplary embodiment of the present invention. As shown, the force-based input device 910 comprises a fixed frame 912 operably related to a base support 914 having an input member 950. The fixed frame 912 is separate and independent of the base support 914, with the two defining a gap 916 therebetween.

Disposed about the gap 916 and operably coupling the fixed frame 912 to the base support 914 is a module 960 having at least one sensing component 930 formed thereon, wherein the sensing component 930 further comprises a pair of sensors 938 operable therewith. In this particular embodiment, the sensing component 930 is defined by channel 962 and aperture 961 being formed within the module 960, as shown. In addition, each of the respective sensors may be strategically located along or proximate an axis of an edge of the module 960 in order to position these at the regions of highest stress concentration within the sensing component 930.

In this particular embodiment, a second sensing component 930-b is also shown, being defined similar to sensing component 930-a. Each of the sensing components 930-a and 930-b comprise one or more sensors associated therewith. In addition, the module 960 is configured so as to locate the sensing components in a position where they cannot be interfered with the fixed frame 912 or the base support 914. Again, it is intended that the force-based input device comprise two or more similar modules positioned about the input device.

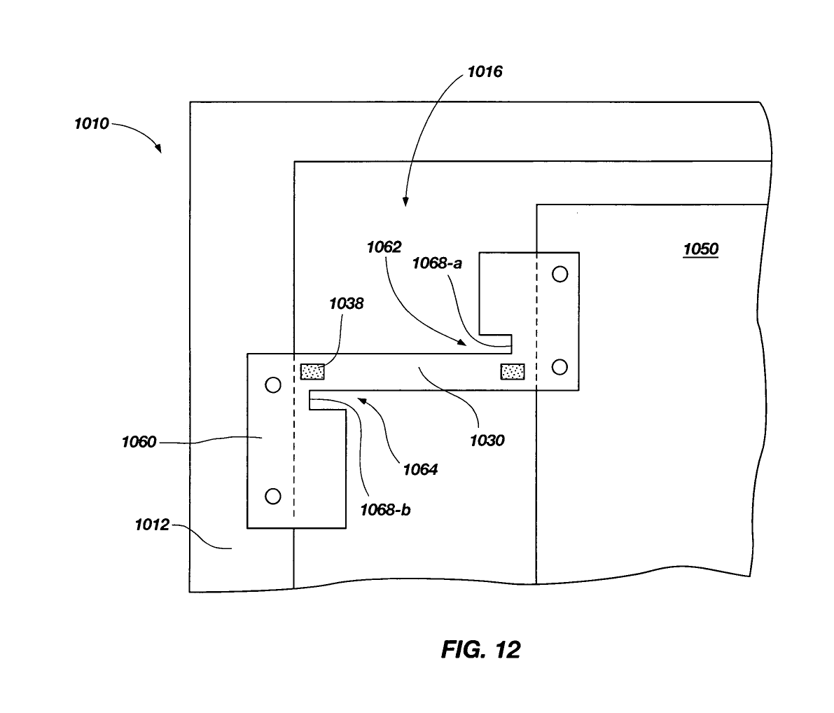

With reference to FIG. 12, illustrated is a force-based input device utilizing a modular sensing component, in accordance with another exemplary embodiment of the present invention. As shown, the force-based input device 1010 comprises a fixed frame 1012 operably related to a base support 1014 having an input member 1050. The fixed frame 1012 is separate and independent of the base support 1012, with the two defining a gap 1016 therebetween.

Disposed about the gap 1016 and operably coupling the fixed frame 1012 to the base support 1012 is a module 1060 having at least one sensing component 1030 formed thereon, wherein the sensing component 1030 further comprises a pair of sensors 1038 operable therewith. In this particular embodiment, the sensing component 1030 is defined by channels 1062 and 1064, as shown, with the sensors being located on the sensing component at a position about respective axes extending along edges 1068-a and 1068-b, respectively, again to provide sensing at the highest regions of stress concentration within the sensing component 1030.

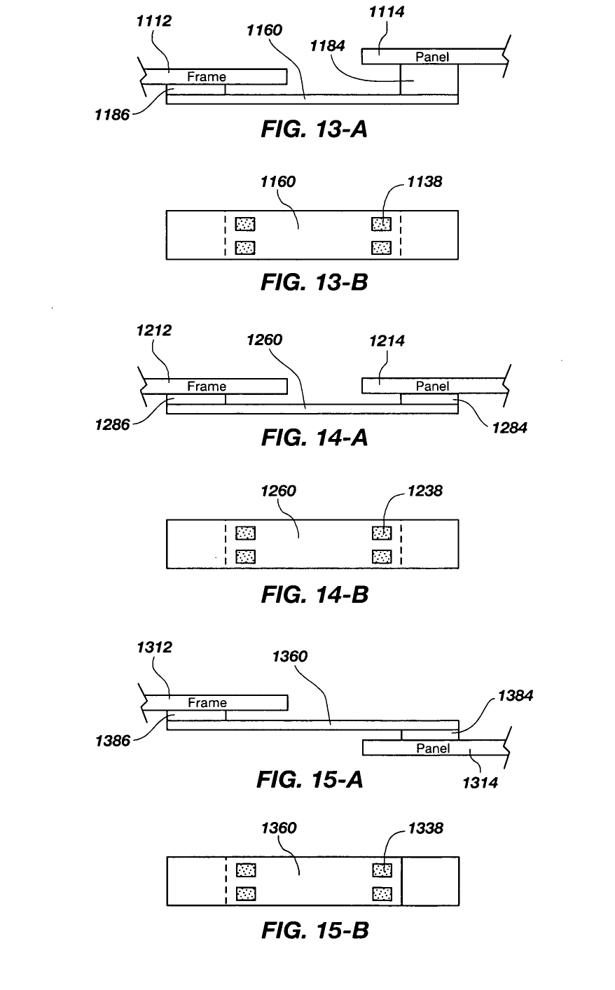

FIGS. 13-17 illustrate several additional exemplary force-based input devices utilizing a modular sensing component design. These embodiments all comprise similar elements as the force-based input devices described above and shown in the drawings, with some notable differences. Specifically, each of the embodiments in FIGS. 13-17 comprise an input device that utilizes one or more spacers operable with the module to interface between the fixed frame and the base support. Stated differently, the spacers permit the module to indirectly couple the fixed frame and the base support, rather than in a direct manner as shown in previous embodiments. Moreover, the spacers are adapted to assist in proper and efficient transfer of resultant forces from the base support and input pad to the module, and eventually to the sensing components and sensors. The spacers provide means for controlling the direction and path of force transfer. In addition, the spacers permit the fixed frame and base support to be in different planes, different orientations (e.g., perpendicular, on an incline, etc.), rather than simply being coplanar or parallel to one another as shown in previous embodiments. For example, the fixed frame may be oriented in a vertical orientation with respect to a ground surface for mounting or other purposes, with the input pad oriented horizontally or on an incline with respect to the fixed frame.

FIGS. 13-A and 13-B comprise an exemplary force-based input device 1110 having a fixed frame 1112 and a base support 1114 constrained by a module 1160 comprising a sensing component 1130 having sensors 1138 disposed thereon and operable therewith. The module 1160 is indirectly coupled to the base support via spacer 1184 and to the fixed frame via spacer 1186. The base support 1114 is shown as residing in a different elevation than the fixed frame 1112, with the module 1160 being planar, thus requiring spacer 1184 to comprise a greater height than the spacer 1186. In addition, the spacers are shown as being coupled to the same side of the module, as well as to the underside of the fixed frame and base support, respectively.

FIGS. 14-A and 14-B comprise an exemplary force-based input device 1210 having a fixed frame 1212 and a base support 1214 constrained by a module 1260 comprising a sensing component 1230 having sensors 1238 disposed thereon and operable therewith. In this embodiment, the fixed frame and base support are coplanar with one another, and the spacers each comprise a similar size and configuration.

FIGS. 15-A and 15-B comprise an exemplary force-based input device 1310 having a fixed frame 1312 and a base support 1314 constrained by a module 1360 comprising a sensing component 1330 having sensors 1338 disposed thereon and operable therewith. In this embodiment, the fixed frame and base support are offset from one another in different elevations. However, unlike the embodiment of FIGS. 13-A and 13-B, the spacers are coupled to opposite sides of the module. In addition, the spacer 1386 interfaces with the underside of the fixed frame, while the spacer 1384 interfaces with the top surface of the base support.

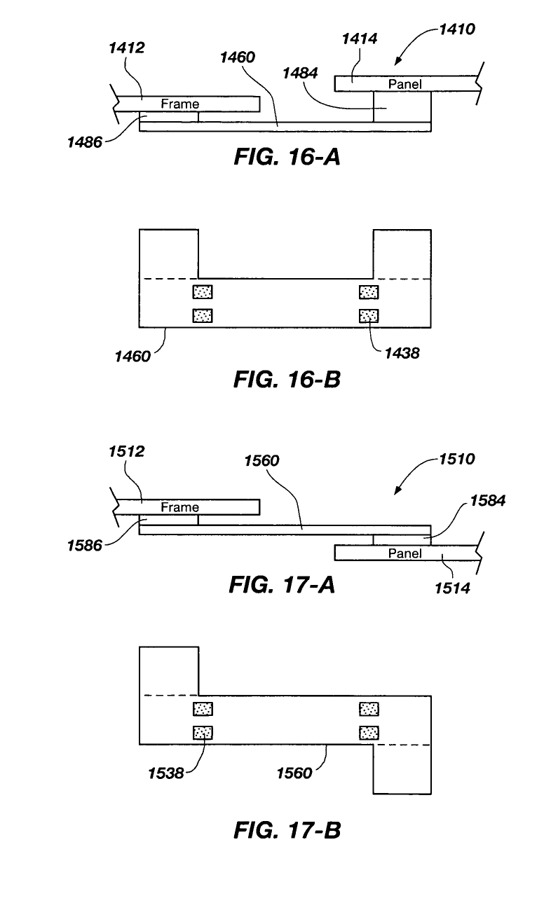

FIGS. 16-A and 16-B comprise an exemplary force-based input device 1410 having a fixed frame 1412 and a base support 1414 constrained by a module 1460 comprising a sensing component 1430 having sensors 1438 disposed thereon and operable therewith. In this embodiment, the base support and fixed frame are offset in different elevations, with spacers 1484 and 1486 being of different heights to accommodate this. The spacers each couple to a common side of the module and to the undersides of the base support and fixed frame. This embodiment also illustrates the spacers being offset from the module itself, both about a common side.

FIGS. 17-A and 17-B comprise an exemplary force-based input device 1510 having a fixed frame 1512 and a base support 1514 constrained by a module 1560 comprising a sensing component 1530 having sensors 1538 disposed thereon and operable therewith. In this embodiment, the base support and fixed frame are again offset in different elevations. The spacers interface with opposing sides of the module, and couple to an underside of the fixed frame and a top surface of the base support. The spacers are also offset from the module itself, being on opposing sides.

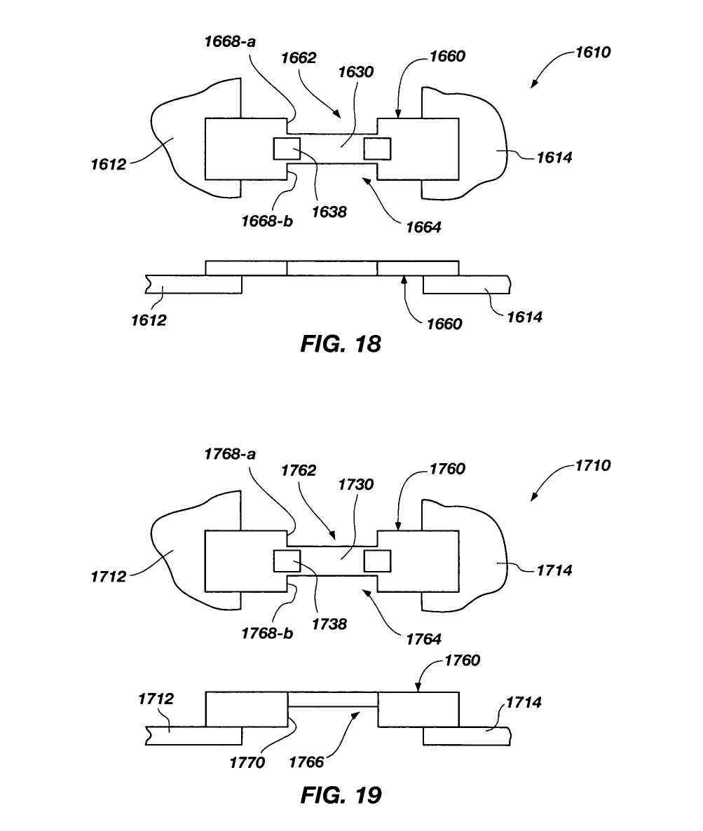

FIGS. 18-A and 18-B illustrate still another exemplary embodiment of a force-based input device formed in accordance with present invention. The force-based input device 1610 comprises a fixed frame element 1612 and a base support 1614 (having an input pad (not shown)). Similar to other embodiment discussed herein, the input device further comprises a module 1660 configured to constrain and couple together the fixed frame and the base support, the module comprising a sensing component 1630 and one or more sensors 1638. In this particular embodiment, the module 1660 comprises a substantially planar configuration having a uniform thickness, and is coupled directly to the surfaces of the fixed frame and base support. Slots 1662 and 1664 are formed in the module in order to further define the sensing component, as well as edges 1668-a and 1668-b. These edges are strategically configured to provide higher concentrations of stresses in the module in a region along an axis extending between edges 1668. The sensors are disposed about the module and positioned to be along the axis extending between the edges, thus functioning to sense the region of high stress concentrations.

FIGS. 19-A and 19-B illustrate still another exemplary embodiment of a force-based input device 1710 also comprising a fixed frame 1712 and a base support 1714 (having an input pad (not shown)). The input device further comprises a module 1760 configured to constrain and couple together the fixed frame and the base support, the module comprising a sensing component 1730 and one or more sensors 1738. The module comprises a non-uniform thickness with slot 1766 formed in a bottom surface thereof, thus defining an edge 1770 orthogonal to the upper surface of the module. The module further comprises slots 1762 and 1764 formed therein that are planar. Slots 1762, 1764 and 1766 function to define the sensing component 1730. The different edges formed by these slots are strategically configured to provide higher concentrations of stresses within the module along axes extending from these edges. The sensors are located along or proximate these axes so as to sense the regions of high stress concentration.

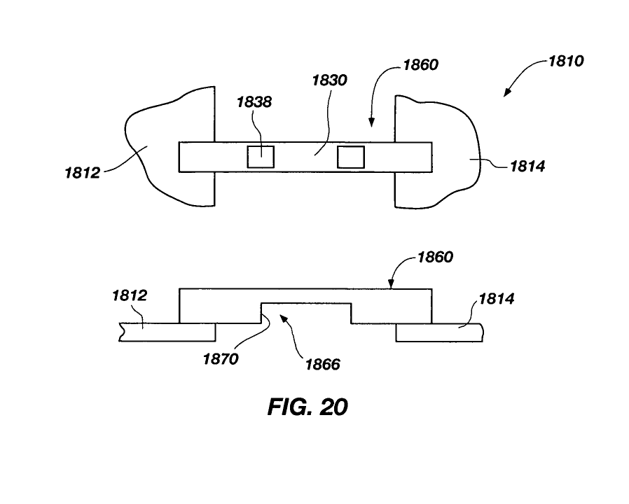

FIGS. 20-A and 20-B illustrate still another exemplary embodiment of a force-based input device 1810. The input device comprises a fixed frame 1812 and a base support 1814 located coplanar with respect to one another. The input device comprises a module 1860 configured to constrain and couple together the fixed frame and the base support, the module comprising a sensing component 1830 and one or more sensors 1838. This embodiment is similar to the one discussed above and shown in FIGS. 19-A and 19-B, except that the module only comprises a slot 1870 formed in an underside thereof to define edges 1870 and the sensing component 1830 for the purpose of strategically directing the concentration of stresses to a particular region of the module. Sensors 1838 are located in the regions of high stress concentration defined along an axis extending from the edge 1870.

### Processing Means

As indicated above, the present invention force-based input device may comprise one or more sensors configured to output a data signal that may be used to facilitate the determination of a location of the applied force about the input member. Based on this, it is contemplated that the present invention further comprises one or more processing means that may receive and utilize the data signals output by the sensors and perform various processing steps to determine the location or coordinates of the applied forces, and/or the magnitude of the applied forces, acting on the contacting element for one or more purposes.

Exemplary techniques for processing signals from the sensors are disclosed in commonly owned, co-pending U.S. patent application Ser. No. 11/402,694, filed Apr. 11, 2006, and entitled, “Force-based Input Device”; U.S. patent application Ser. No. 11/402,985, filed Apr. 11, 2006, and entitled “Sensor Signal Conditioning in a Force-Based Input Device”; and U.S. patent application Ser. No. 11/402,692, filed Apr. 11, 2006, and entitled “Sensor Baseline Compensation in a Force-Based Touch Device”, each of which are incorporated by reference herein in their entirety.

Other processing means and methods may be employed by the present invention that are known to those skilled in the art. For example, U.S. Pat. Nos. 4,121,049 to Rober; and 4,340,772 to DeCosta et al. disclose and discuss exemplary processing methods that may be incorporated for use with the present invention. As such, the present invention should not be limited to any particular processing means or methods, as each of these is contemplated for use and may be implemented with the force-based touch pad of the present invention to perform its intended function of processing the signal(s) received from the various sensors for one or more purposes.

It is noted herein that, with respect to inertia, the baseline outputs of the sensors may depend on the orientation of the input member. The mass of the input member may produce different forces depending on its orientation. The baseline estimation system corrects this over the long term. An accelerometer may be used to estimate the tilt and correct the baseline, if the input member is to operate after the orientation is changed. This approach should also account for vibrations at frequencies well below the resonant frequencies of the input member. With current technology, accelerometers that are sensitive enough to compensate for tilt may saturate at any significant vibration, so multiple separate accelerometers may be used to compensate for both orientation changes and vibration.

The foregoing detailed description describes the invention with reference to specific exemplary embodiments. However, it will be appreciated that various modifications and changes can be made without departing from the scope of the present invention as set forth in the appended claims. The detailed description and accompanying drawings are to be regarded as merely illustrative, rather than as restrictive, and all such modifications or changes, if any, are intended to fall within the scope of the present invention as described and set forth herein.

More specifically, while illustrative exemplary embodiments of the invention have been described herein, the present invention is not limited to these embodiments, but includes any and all embodiments having modifications, omissions, combinations (e.g., of aspects across various embodiments), adaptations and/or alterations as would be appreciated by those in the art based on the foregoing detailed description. The limitations in the claims are to be interpreted broadly based on the language employed in the claims and not limited to examples described in the foregoing detailed description or during the prosecution of the application, which examples are to be construed as non-exclusive. For example, in the present disclosure, the term “preferably” is non-exclusive where it is intended to mean “preferably, but not limited to.” Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein. Accordingly, the scope of the invention should be determined solely by the appended claims and their legal equivalents, rather than by the descriptions and examples given above.

What is claimed and desired to be secured by Letters Patent is:

1. A force-based input device responsive to an applied force to determine a location of said applied force, said force-based input device comprising:
a fixed frame;
a base support independent of and operable with said fixed frame and comprising an input pad adapted to receive said applied force and to displace relative to said fixed frame;
a module adapted to constrain said base support and said fixed frame, said module comprising a sensing component adapted to receive resultant forces as distributed from the displacement of the input pad caused by the applied force, and to undergo a degree of deflection, the module being adapted to constrain movement of the base support and fixed frame in all directions with respect to one another, with constraint of off-axis forces being the greatest; and
a sensor operable with said sensing component to output a signal corresponding to said degree of deflection of said sensing component, said signal facilitating the determination of a location of said applied force.
